(19) United States
(12) Patent Application Publication
(10) Pub. No.: US 2014/0002315 A1
(43) Pub. Date: Jan. 2, 2014

(54) ANTENNA AND METHOD FOR MANUFACTURING THE SAME

(71) Applicant: LG INNOTEK CO., LTD., Seoul (KR)

(72) Inventor: Dong Uk LIM, Seoul (KR)

(73) Assignee: LG INNOTEK CO., LTD., Seoul (KR)

(21) Appl. No.: 13/755,820

(22) Filed: Jan. 31, 2013

(30) Foreign Application Priority Data
Jun. 29, 2012 (KR) 10-2012-0071193

(51) Int. Cl. H01Q 1/50; H01Q 1/24; H01P 11/00; H01Q 1/36

(52) U.S. Cl. CPC H01Q 1/50; H01Q 1/36; H01Q 1/243; H01P 11/00
USPC 343/702; 343/700 MS; 343/749; 29/600

(57) ABSTRACT

An antenna according to an embodiment includes a structure, and an antenna pattern on the structure, wherein the antenna pattern includes a feeding structure and a radiator integrated with the feeding structure for radiating a signal provided from the feeding structure to an outside.

### CROSS-REFERENCE TO RELATED APPLICATION

This application claims the benefit under 35 U.S.C. §119 of Korean Patent Application No. 10-2012-0071193, filed Jun. 29, 2012, which is hereby incorporated by reference in its entirety.

### BACKGROUND

The embodiment relates to an antenna and a method for manufacturing the same.

Recently, a mobile communication terminal is requested to have a smaller and lighter structures as well as a function of receiving mobile communication services of different frequency bands. For example, in order to utilize mobile communication services using various frequency bands, such as CDMA service in the band of 824˜894 MHz commercialized in Republic of Korea, PCS service in the band of 1750˜1870 MHz, CDMA service in the band of 832˜925 MHz commercialized in Japan, PCS service in the band of 1850˜1990 MHz commercialized in U.S.A., GSM service in the band of 880˜960 MHz commercialized in Europe and China, DCS service commercialized in some parts of Europe, a terminal which can simultaneously use signals in multiple bands as necessary is required and an antenna having the broadband characteristic is also required to receive the signals having the multiband characteristics.

Further, a complex terminal, which can use services such as Bluetooth, Zigbee, wireless LAN and the like, has been still requested. In order to use such a multiple band service, a terminal must include an antenna having the broadband characteristics. As a generally used antenna for a mobile communication terminal, in general, a helical antenna, a PIFA (Planer Inverted F Antenna), and a pi-shaped broadband antenna are mainly used.

The helical antenna is an external antenna fixed at an upper end of a terminal and is used together with a monopole antenna. In the case of a combined antenna having the function of the helical antenna and the monopole antenna, if the combined antenna is extended out from the terminal body, the combined antenna is operated as the monopole antenna, and if retracted, the combined antenna is operated as the λ/4 helical antenna. Although this antenna has a merit of obtaining a great gain, the antenna has no orientation so the SAR characteristic which is a measure of radio frequency energy absorbed by human tissue may be degraded. Further, since the helical antenna is configured to protrude from the outer surface of a terminal, it is difficult to design the external appearance to be suitable for an aesthetic appearance and a portable function of the terminal. In addition, the embedded structure for the antenna has not been studied yet.

The inverted F antenna is an antenna designed to have a low-profile structure to remove the above-mentioned defects. The inverted F antenna attenuates beams toward a human body by re-inducing beams toward a ground among the entire beams generated by a current induced at the radiator, so that the SAR characteristic is improved. At the same time, the inverted F antenna has orientation to enhance the beams induced toward the radiator, and operates as a rectangular micro-strip antenna including a rectangular plate-shaped radiator the length of which is reduced in half, so that a low profile structure is implemented. Further, the monopole type antenna is used as an embedded antenna for the implementation of a low profile structure.

Further, a broadband antenna serves as an antenna having a feeding structure, and has not only a simple structure, but also a broadband characteristic.

However, in the broadband antenna, a radiator and a feeding structure, which are generally included in an antenna, are attached to different structures, respectively, so the broadband antenna is configured by connecting the radiator and the feeding structure which are attached to the plural structures to each other.

Thus, the radiator and the feeding structure must be individually manufactured, so that the manufacturing process is complex.

### BRIEF SUMMARY

The embodiment provides an antenna and a method for manufacturing the same to simplify structural complexity of a broadband antenna of the related art.

The embodiment provides an antenna and a method for manufacturing the same, in which a radiator and a feeding structure are integrally formed with each other as a pattern so that the integral pattern can be attached to a single structure.

The technical objects which will be achieved in the proposed embodiments are not limited to the above, but other technical objects which are not mentioned will be apparently understood to those skilled in the art.

An antenna according to an embodiment includes a structure, and an antenna pattern on the structure, wherein the antenna pattern includes a feeding structure and a radiator integrated with the feeding structure for radiating a signal provided from the feeding structure to an outside.

Further, the feeding structure includes a feeder for providing a signal, and a closed loop formed of a capacitive device and a conductive line.

Further, the feeding structure includes a feeder for providing a signal, a first closed loop formed of a first capacitive device and a conductive line, and a second closed loop formed by the first capacitive device, a second capacitive device and a conductive line.

Further, the structure includes a back cover of an apparatus to which the structure is applied.

Further, the radiator is attached to a first surface of the structure, and the feeding structure is attached to a second surface of the structure which is different from the first surface.

Meanwhile, a method for manufacturing an antenna according to an embodiment includes the steps of: printing an antenna pattern on a plate; mounting a capacitive device on the printed antenna pattern; cutting the antenna pattern on which the capacitive device is mounted; and attaching the cut antenna pattern to an injection molded structure, wherein the printing of the antenna pattern includes printing an antenna pattern which includes a feeding structure and a radiator integrated with the feeding structure for radiating a signal provided from the feeding structure to an outside.

Further, the structure includes a back cover of an apparatus to which the structure is applied.

Further, the step of attaching the cut antenna pattern includes the steps of attaching a radiator area in the integrally formed antenna pattern to a first surface of the structure; and attaching a feeding structure area in the integrally formed antenna pattern to a second surface of the structure different from the first surface.

Further, the step of attaching the cut antenna pattern includes the steps of: attaching the cut antenna pattern on the structure by thermal-depositing the cut antenna pattern.

According to the embodiments, in the pi-shaped antenna, the radiator and the feeding structure are formed in one integral pattern, and thus, by attaching the integral pattern to one structure, any flexible printed circuit board is unnecessary, so that the manufacturing cost may be reduced.

Further, according to the embodiment, the radiator and the feeding structure can be formed at a time, so that a manufacturing process may be simplified and the curve design freedom and the adhesion of the structure may be improved.

### BRIEF DESCRIPTION OF THE DRAWINGS

FIG. 1 is a view illustrating a feeding structure for an antenna according to a first embodiment;

FIG. 2 is a view showing various examples of the feeding structure of the antenna according to the embodiment;

FIG. 3 is a view showing an antenna employing the feeding structure depicted in FIG. 1 according to the first embodiment;

FIG. 4 is a view illustrating a feeding structure for an antenna according to a second embodiment;

FIG. 5 is a view illustrating an operation principle of the feeding structure depicted in FIG. 4;

FIG. 6 is a view showing an antenna to which a feeding structure depicted in FIG. 4 is applied according to the second embodiment;

FIG. 7 is a view illustrating a structure of an antenna according to an embodiment; and

FIG. 8 is a flowchart sequentially illustrating a method for manufacturing an antenna according to an embodiment.

### DETAILED DESCRIPTION

The principle of the embodiments will be described below. Therefore, although not specifically described and depicted in the specification, a person having the ordinary skill in the art may realize the principle of the embodiments and may invent various apparatuses within the concept and scope of the embodiments. Further, in principle, conditional terms and embodiments mentioned in the specification shall be obviously intended to understand the concept of the embodiments and may not limit the scope of the embodiments.

Further it shall be understood that all detailed descriptions, which teach a specific embodiment as well as a principle, an aspect and embodiments, are intended to include structural and functional equivalents. Further, it should be understood that the equivalents may include equivalents to be developed in the future as well as known equivalents and may include all devices invented for performing the same functions regardless of the structure thereof.

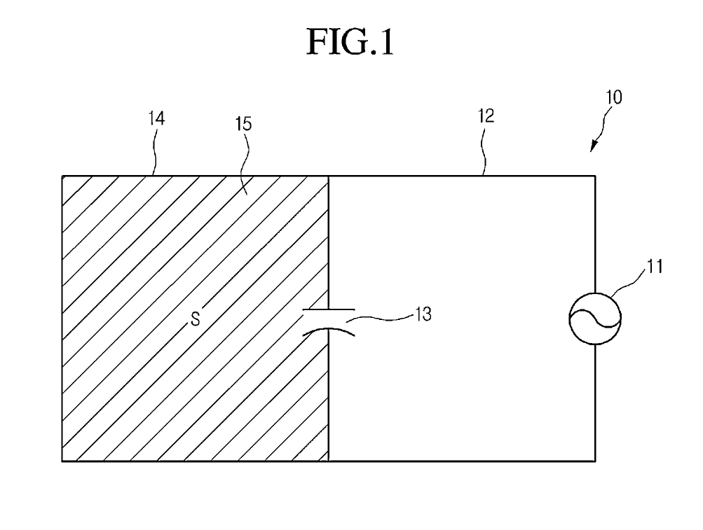

FIG. 1 is a view illustrating a feeding structure for an antenna according to a first embodiment.

As shown in FIG. 1, the feeding structure for the antenna according to the embodiment includes a feeder 11, a capacitive device 13, a first conductive line 12 of connecting both terminals of the feeder 11 with both terminals of the capacitive device 13, and a second conductive line 14 of connecting both terminals of each of the feeder 11 and the capacitive device 13 to each other.

The feeder 11 may be configured with only a feeding source or may include the feeding source and a matching device for an impedance matching.

Meanwhile, the second conductive line 14, which connects both terminals of the capacitive device 13 to each other, forms a closed loop having a predetermined area S together with the capacitive device 13.

The operation principle of the feeding structure depicted in FIG. 1 will be described below. In RF environment, inductance by the conductive line and the loop is generated at the closed loop 15 formed with the capacitive device 13 and the second conductive line 14.

The inductance and the capacitive device 13 cause resonance at a specific frequency. The current flowing through the closed loop 15 generates a magnetic flux, which is provided to an antenna radiator.

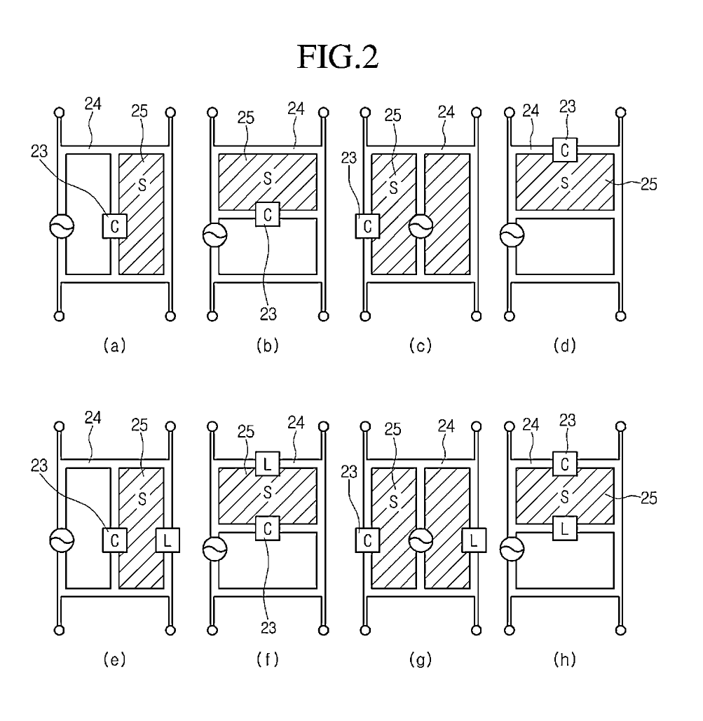

FIG. 2 is a view showing various examples of the feeding structure of the antenna according to the embodiment. Although various types of feeding structures of the antenna are depicted in FIG. 2, the feeding structures have common characteristics described with reference to FIG. 1.

That is, a conductive line 24 and a capacitive device 23 form a closed loop 25. The inductance by the closed loop 25 and the capacitance by the capacitive device 23 cause resonance. The magnetic flux generated from the closed loop 25 may be provided to the antenna radiator.

Meanwhile, as shown in (e), (f), (g) and (h) of FIG. 2, the closed loop 25 includes not only the capacitive device 23 and the conductive line 24, but also an inductive device L. The inductive device L supplements the inductance generated by the closed loop 25.

That is, in order to generate resonance at a desired frequency, when the inductance generated only by the closed loop 25 is insufficient, inductance generated by a lumped circuit device is added such that the inductance shortage is compensated.

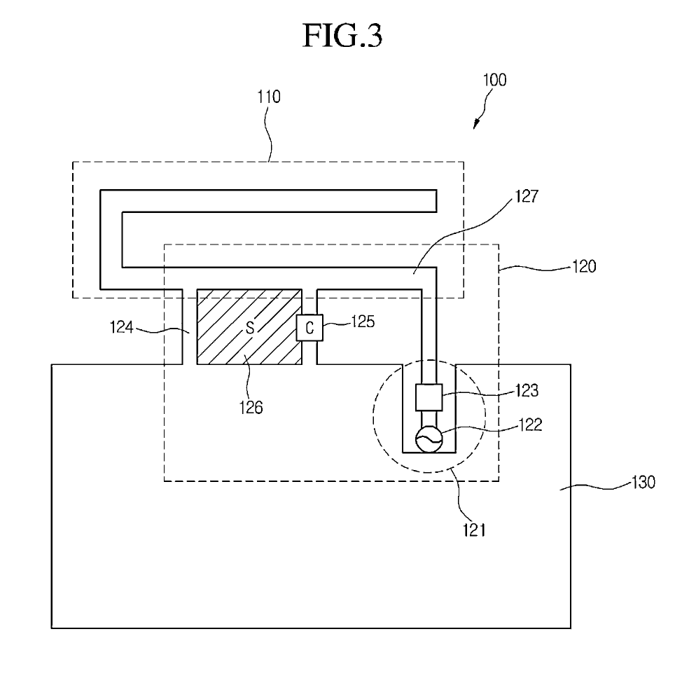

FIG. 3 is a view showing an antenna employing the feeding structure depicted in FIG. 1 according to the first embodiment.

Referring to FIG. 3, the antenna according to the embodiment a radiator 110, a feeding structure 120 and a ground 130.

The feeder 121 may exclusively include a feeding source 122 or may further include a matching device 123 for an impedance matching in addition to the feeding source 122.

The feeder 121, a first conductive line 127, a capacitive device 124 and a second conductive line 124 may constitute the feeding structure 120 depicted in FIG. 1.

Although the feeding structure 120 depicted in FIG. 1 is applied to the antenna according to the embodiment, the feeding structure depicted in FIG. 2 may be selectively applied.

As cleared in the description about the feeding structure of FIG. 1, due to the inductance of a closed loop 126 and the capacitance of the capacitive device 125, resonance occurs at a specific frequency.

The closed loop 126 is formed by the capacitive device 125 and the second conductive line 124. The current by the resonance causes a magnetic flux at the closed loop 126. If the radiator is excited by the magnetic flux generated from the closed loop 126, a signal is radiated to an outside through the radiator 110 at the resonant frequency.

It can be understood from the frequency characteristics of the above-described antenna that the frequency band is widened in comparison with that of the related art.

That is, if the above-described feeding structure is applied, a resonance band by the feed structure is added in addition to the resonance band by the antenna radiator, so that the band of the antenna can be widened. This antenna is called a pi-shaped wideband antenna.

Thus, a wideband antenna may be designed by controlling values of capacitance and inductance causing resonance in such a manner that a resonance band by the feeding structure can be generated near a resonance frequency of a radiator of the related art.

At this time, the capacitance necessary for controlling the resonance band may be obtained by changing a capacitance value of a lamped-circuit device. Further, the inductance value necessary for controlling the resonance band may be obtained by controlling an area of the closed loop or inserting an inductor which is a lumped-circuit device.

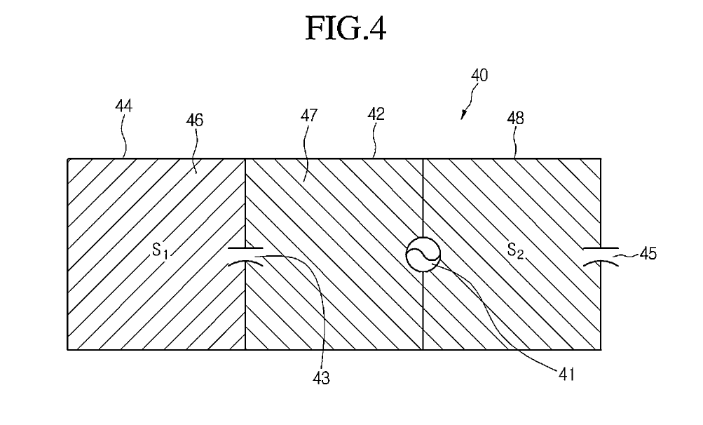

FIG. 4 is a view illustrating a feeding structure for an antenna according to a second embodiment. As shown in FIG. 4, the feeding structure for the antenna according to the second embodiment includes a feeder 41, a first capacitive device 43, a second capacitive device 45, a first conductive line 42, a second conductive line 44, and a third conductive line 48.

The feeder 41 may exclusively include a feeding source, or may include the feeding source and a matching device for an impedance matching.

The first conductive line 42 connects both terminals of the feeder 41 and the both terminals of the first capacitive device 43 to each other. Meanwhile, the second conductive line 44 connecting both terminals of the first capacitive device 43 may form a first closed loop 46 having a predetermined area S1 together with the capacitive device 43.

In addition, the first and second capacitive devices 43 and 45 and the first and third conductive lines 42 and 48 connecting the first and second capacitive devices 43 and 45 may form a second closed loop 47 having a predetermined area S2.

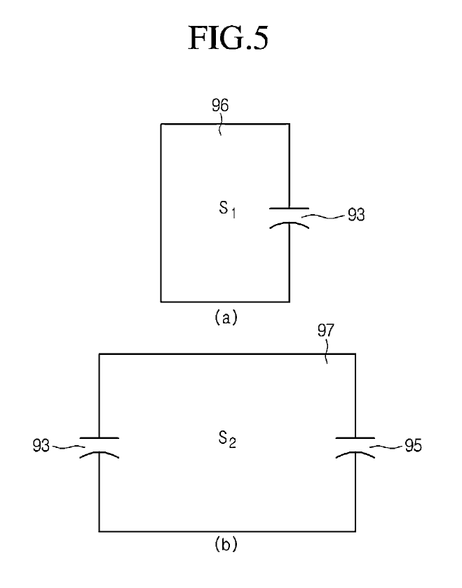

FIG. 5 is a view illustrating an operation principle of the feeding structure depicted in FIG. 4. If the capacitance of the first capacitive device 43 is much larger than that of the second capacitive device 45, the feeding structure depicted in FIG. 4 has two main resonance bands.

FIG. 5 (a) illustrates a first resonance circuit in which resonance is generated in a low frequency area. Since any current cannot flow through the second capacitive device 45, resonance occurs at the first closed loop 46. That is, a first resonance band is formed by the inductance provided from the first closed loop 46 and the capacitance provided from the first capacitive device 43.

FIG. 5 (b) illustrates a second resonance circuit in which resonance is generated in a high-frequency area. Since inductance of a conductive line is increased in a high-frequency area such that any current cannot flow through the first closed loop 46, resonance is caused by the second closed loop 47. That is, the resonance is caused by the inductance provided by the second closed loop 47 and the capacitance provided by the first and second capacitive devices 43 and 45 (capacitance mainly provided by the second capacitive device).

The first and second closed loops 46 and 47 provide magnetic fluxes generated at the resonance frequency band thereof to the antenna radiator.

Thus, the antenna radiator radiates RF signals to the outside at the resonance frequency band of each closed loop.

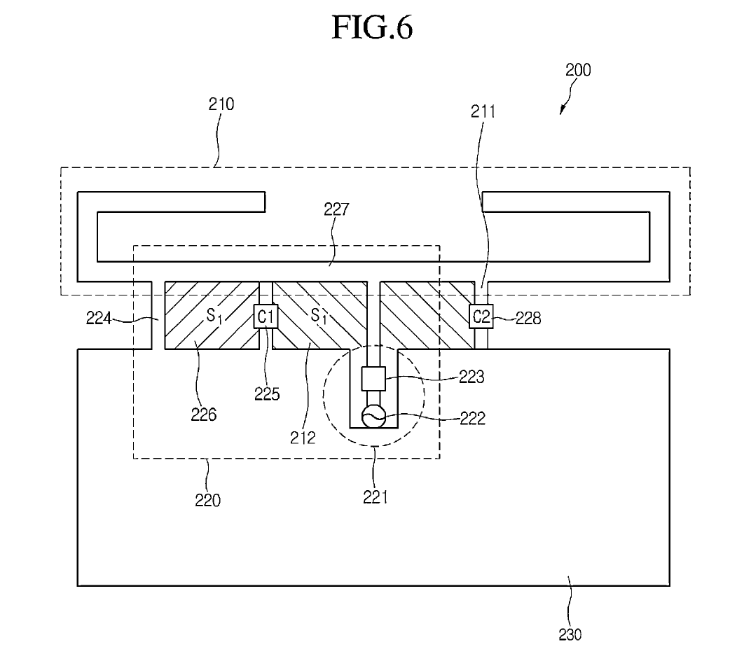

FIG. 6 is a view showing an antenna to which a feeding structure depicted in FIG. 4 is applied according to the second embodiment.

Referring to FIG. 6, the antenna 200 according to the second embodiment includes a radiator 210, a feeding structure 220 and a ground 230.

A feeder 221 may exclusively include a feeding source 222, or may include the feeding source 222 and an additional matching device 223 for an impedance matching.

The feeder 221, a first conductive line 227, a first capacitive device 225, a second conductive line 224, a second capacitive device 228, and a third conductive line 211 may constitute the feeding structure as depicted in FIG. 4.

As described in the description of the feeding structure depicted in FIG. 4, resonance occurs at a first resonance frequency by a first closed loop 226.

At this time, the first closed loop 226 may consist of the first capacitive device 225 and the second conductive line 224.

Further, the resonance occurs due to the capacitance provided by the first capacitive device 225 and the inductance provided by the first closed loop 226.

Resonance occurs at a second resonance frequency by the second closed loop 212. At this tine, the second closed loop 212 is formed by the first capacitive device 225, the first conductive line 227, the third conductive line 211 and the second capacitive device 228.

Further, the resonance occurs due to the inductance provided by the second closed loop 212 and the capacitance provided by the first and second capacitive devices 225 and 228.

The currents caused by the resonances may generate magnetic fluxes at each resonance frequency, and when the radiator 210 is excited by the magnetic fluxes generated by each closed loop 226 and 212, signals are radiated to an outside through the radiator 210 at the resonance frequencies of each closed loops 226 and 212.

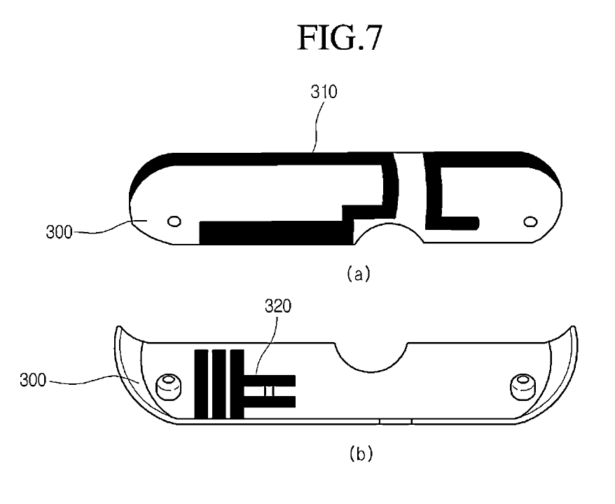

FIG. 7 is a view illustrating a structure of an antenna according to an embodiment.

Referring to FIG. 7, the structure of the antenna includes an injection molded structure 330 and an antenna pattern 310 attached to a surface of the structure 300.

At this time, the antenna pattern 310 includes the radiator 110 or 210 and the feeding structure 120 or 220 as described in FIGS. 1 to 6.

The radiator 110 or 210 and the feeding structure 120 or 220 are integrally formed so as to be attached to a surface of the same structure 300.

The structure 300 may be a carrier having a specific shape which is inserted into a mobile terminal, or may be a back cover which is included in the mobile terminal.

At this time, although the radiator 110 or 210 and the feeding structure 120 or 220 are integrally formed, the radiator 110 or 210 may be attached to a first surface (top surface) of the structure 300 and the feeding structure 120 or 220 may be attached to a second surface (bottom surface) different from the first surface along a bent surface of the structure 300.

That is, according to the related art, the radiator 110 or 210 and the feeding structure 120 or 220 have been individually manufactured, and then the radiator 110 or 210 is assembled with the feeding structure 120 or 220, thereby providing the antenna depicted in FIGS. 1 to 6.

To this end, in the related art, the radiator is attached to a first structure, and the feeding structure is attached to a second structure separated from the first structure. Then, the first and second structures to which the radiator and the feeding structure are attached are inserted into a suitable place of a mobile terminal to be connected with each other, so that a wideband antenna is manufactured.

However, in the embodiments, the radiator 110 or 210 and the feeding structure 120 or 220 are formed as an integral pattern, and thus, the radiator 110 or 210 and the feeding structure 120 or 220 can be attached to one structure.

According to the embodiments, in a pi-shaped antenna, the radiator and the feeding structure are formed as one integral pattern, and the integral pattern is attached to one structure, so a flexible printed circuit board required in the related art may not be necessary, so that the manufacturing cost may be reduced.

Further, according to the embodiment, the radiator and the feeding structure are formed at a time, so that a manufacturing process may be simplified and the curve design freedom and the adhesion of the structure may be improved.

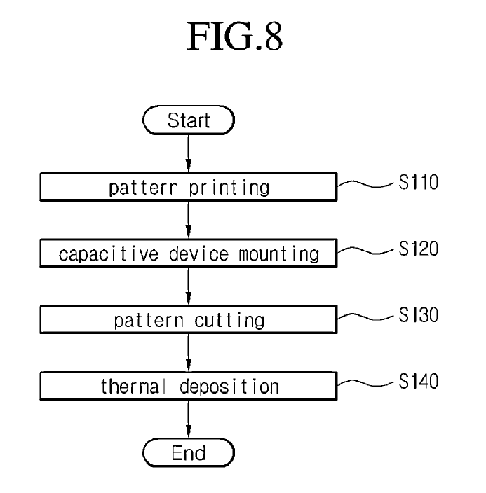

FIG. 8 is a flowchart sequentially illustrating a method for manufacturing an antenna according to an embodiment.

Referring to FIG. 8, in step S110, an antenna pattern is printed on a metal plate. At this time, the printed antenna pattern is a pattern in which a radiator 110 or 210 and a feeding structure 120 or 220 are integrally formed.

Then, in step S120, a capacitive device is mounted on a specific place on the formed antenna pattern.

Further, in step S130, if the capacitive device has been mounted, the antenna pattern on which the capacitive device is mounted is cut.

Then, in step S140, the antenna pattern on which the capacitive device is mounted is attached to one structure by using a thermal deposition scheme.

According to the embodiments, in the pi-shaped antenna, the radiator and the feeding structure are formed as one integral pattern, and the integral pattern is attached to one structure, so the flexible printed circuit board required in the related art may not be necessary, so that the manufacturing cost may be reduced.

Further, according to the embodiment, the radiator and the feeding structure are formed at a same time, so that a manufacturing process may be simplified and the curve design freedom and the adhesion of the structure may be improved.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An antenna comprising:
a structure; and
an antenna pattern on the structure,
wherein the antenna pattern includes a feeding structure and a radiator integrated with the feeding structure for radiating a signal provided from the feeding structure to an outside.

2. The antenna of claim 1, wherein the feeding structure includes a feeder for providing a signal; and
a closed loop formed by a capacitive device and a conductive line.

3. The antenna of claim 1, wherein the feeding structure includes a feeder for providing a signal;
a first closed loop formed by a first capacitive device and a conductive line; and
a second closed loop formed by the first capacitive device, a second capacitive device and a conductive line.

4. The antenna of claim 1, wherein the structure includes a back cover of an apparatus to which the structure is applied.

5. The antenna of claim 1, wherein the radiator is attached to a first surface of the structure, and the feeding structure is attached to a second surface of the structure which is different from the first surface.

6. A method for manufacturing an antenna, the method comprising:
printing an antenna pattern on a plate;
mounting a capacitive device on the printed antenna pattern;
cutting the antenna pattern on which the capacitive device is mounted; and
attaching the cut antenna pattern to an injection molded structure,
wherein the printing of the antenna pattern comprises printing an antenna pattern which includes a feeding structure and a radiator integrated with the feeding structure for radiating a signal provided from the feeding structure to an outside.

7. The method of claim 6, wherein the structure includes a back cover of an apparatus to which the structure is applied.

8. The method of claim 8, wherein the attaching of the cut antenna pattern includes attaching a radiator area in the integrally formed antenna pattern to a first surface of the structure; and
attaching a feeding structure area in the integrally formed antenna pattern to a second surface of the structure different from the first surface.

9. The method of claim 6, wherein the attaching of the cut antenna pattern includes attaching the cut antenna pattern on the structure by thermally depositing the cut antenna pattern.
